(19) United States
(12) Patent Application Publication
(10) Pub. No.: US 2013/0208870 A1
(43) Pub. Date: Aug. 15, 2013

(54) MIRCOFOCUS X-RAY TUBE FOR A HIGH-RESOLUTION X-RAY APPARATUS

(71) Applicants: Eberhard Neuser, Wunstorf (DE); Andreas Schmitt, Wunstorf (DE); Wolfgang Johannes Sperner, Wunstorf (DE)

(72) Inventors: Eberhard Neuser, Wunstorf (DE); Andreas Schmitt, Wunstorf (DE); Wolfgang Johannes Sperner, Wunstorf (DE)

(21) Appl. No.: 13/818,994

(22) PCT Filed: Aug. 27, 2010
(86) PCT No.: PCT/EP10/05273

§ 371 Date: Apr. 22, 2013

(51) Int. Cl. H05G 1/02

(52) U.S. Cl. CPC H05G 1/025
USPC 378/138

(57) ABSTRACT

An apparatus is provided for a micro focus X-ray tube for a high-resolution X-ray comprising a housing, an electron beam source for generating an electron beam and a focusing lens for focusing the electron beam on a target. The X-ray tube comprises a substantially rotationally symmetrical, ring-shaped cooling chamber configured to circulate a liquid cooling medium.

The invention relates to a micro-focus X-ray tube for a high-resolution X-ray device comprising of a housing, an electron beam source for generating an electron beam, and a focusing lens for focusing the electron beam on a target.

Such X-ray tubes are known, for example, for high-resolution computer tomography devices.

Due to advances in detector technology, the computing-and storage capacities, as well as the increased resolution of micro-focus X-ray tubes enables the micro-computer tomography volume reconstruction with a very high spatial resolution (voxel size) down to the sub-micrometer range.

Since the measurement of all X-ray projections, which are required for a reconstruction with high resolution, typically takes several hours, thermally-induced displacements of the sample projections cause significant problems on the detector. It is indeed known to compensate these displacements using software-based algorithms. However, the resolution enhancement achievable thereby is limited.

The critical component thereby is the X-ray tube, because it is not possible to fix the tube in the focal spot on a thermally insensitive manipulator; it always remains a thermally sensitive (usually metallic) connection over the tubular housing between the focus and the fixing of the tube to the manipulator, which leads without further measures to the fact that the focus position of the X-ray tube moves considerably over the duration of measurement.

A common measure to keep the focus position of the x-ray tube over the entire measurement duration as constant as possible is to heat up the tube to operating temperature and wait until a thermal equilibrium is reached before the scans are started. However, it takes several hours until the thermal equilibrium is established due to the considerable mass of the X-ray tube and the associated large heat capacity. Furthermore, the thermal equilibrium is disturbed again by each parameter change of the tube, causing additional significant waiting time.

The task of the invention is to provide a micro-focus X-ray tube which allows to obtains data in a shorter time with a higher resolution in the industrial application.

The invention solves this problem with the features of the independent Claim 1. Due to the cooling of the X-ray tube by means of the cooling fluid flowing through the cooling chamber, thermally-induced displacement of the focus position is counteracted. A key feature is that the cooling chamber is essentially rotationally symmetrical according to the invention. Thereby, the substantially rotationally symmetrical temperature distribution in the tube, which is mainly generated by rotationally symmetrical heat input, can be maintained even when the tube is not in the thermal equilibrium, in particular due to the dissipation of energy in the electron optics and the absorption of thermal energy over the surface of the tubular housing. By maintaining the rotationally symmetrical temperature distribution in the tube, lateral displacements of the focus, i.e., displacements in the axis of rotation arranged perpendicular to the focus plane, will be prevented very effectively. As these displacements in the focal plane have a big impact on the spatial resolution of the detector, a significant increase of the spatial resolution can be achieved according to the invention in the volume reconstruction. A pre-heating of the tube and waiting for adjusting the thermal equilibrium can be foregone, which significantly reduces the total measurement duration.

Due to the substantially rotationally symmetrical cooling according to the invention, only axial thermal displacements of the focus point remain substantially. These have less severe impacts on the spatial resolution of the detector. Furthermore, if necessary, axial thermal displacements of the focus point can be prevented effectively by means of an increased cooling capacity, i.e. a suitably designed cooling pump.

Through the annular cooling chamber, the invention is differentiated by a particularly advantageous helically arranged cooling line around the axis of rotation, where significant deviations occur from the rotational symmetry of the cooling in the axial end regions in particular.

Preferably, the cross-sectional area of the cooling chamber in a longitudinal cross-section is at least five times, more preferably at least ten times as large as the cross-sectional area of the cooling lines to be connected with the cooling chamber. This feature contributes to a particularly efficient cooling due to a greatest possible volume of cooling in the cooling chamber for a given size. For the same reason, the clear internal dimensions of the cooling chamber in a longitudinal cross-section are preferably greater than the wall thickness of the cooling chamber, so that as much installation space available as possible is usable as cooling agent volume.

Preferably, the cooling chamber is shaped annular-cylindrical wherein a radially inner wall and a radially outer wall of the cooling chamber are shaped cylindrically. This form allows a particularly efficient cooling due to a maximum possible volume of cooling at a given size, and is also advantageous in terms of manufacturing technique in addition.

Preferably, an inlet and an outlet for the cooling medium in the circumferential direction of the tube are arranged offset to one another, more preferably offset by at least 90°, still more preferably offset at 180°, i.e. arranged oppositely with respect to the tube axis. This arrangement can contribute to a uniform flow of the entire cooling chamber volume as possible.

The invention is explained below on the basis of advantageous embodiments with reference to the accompanying figures. It shows,

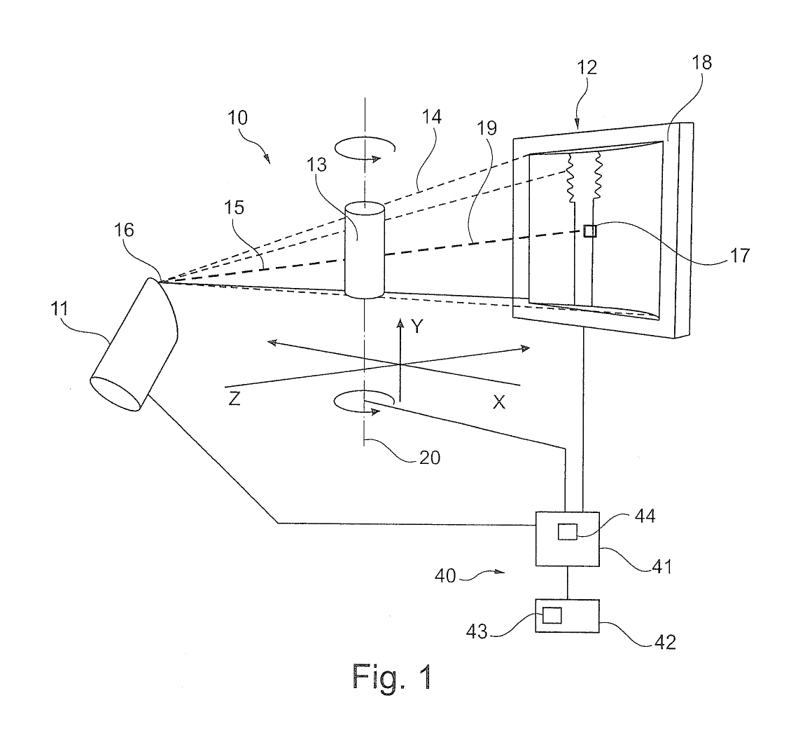

FIG. 1 a schematic representation of a micro-computer tomography system;

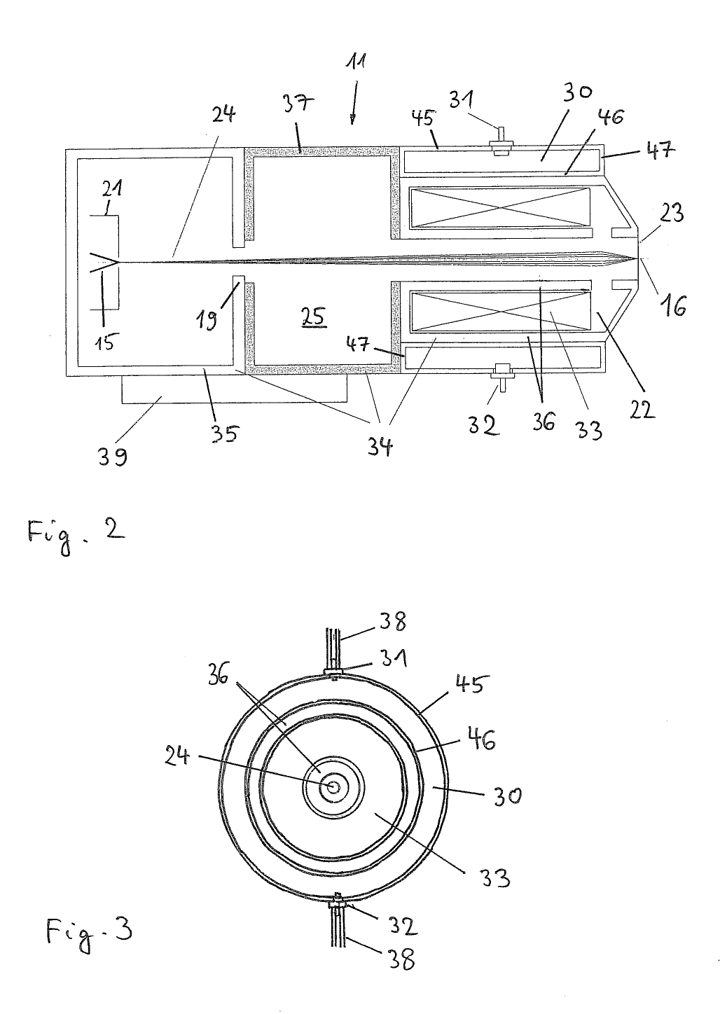

FIG. 2 a longitudinal cross-section through an X-ray tube in a first embodiment;

FIG. 3 a cross-section through an X-ray tube perpendicular to the longitudinal axis;

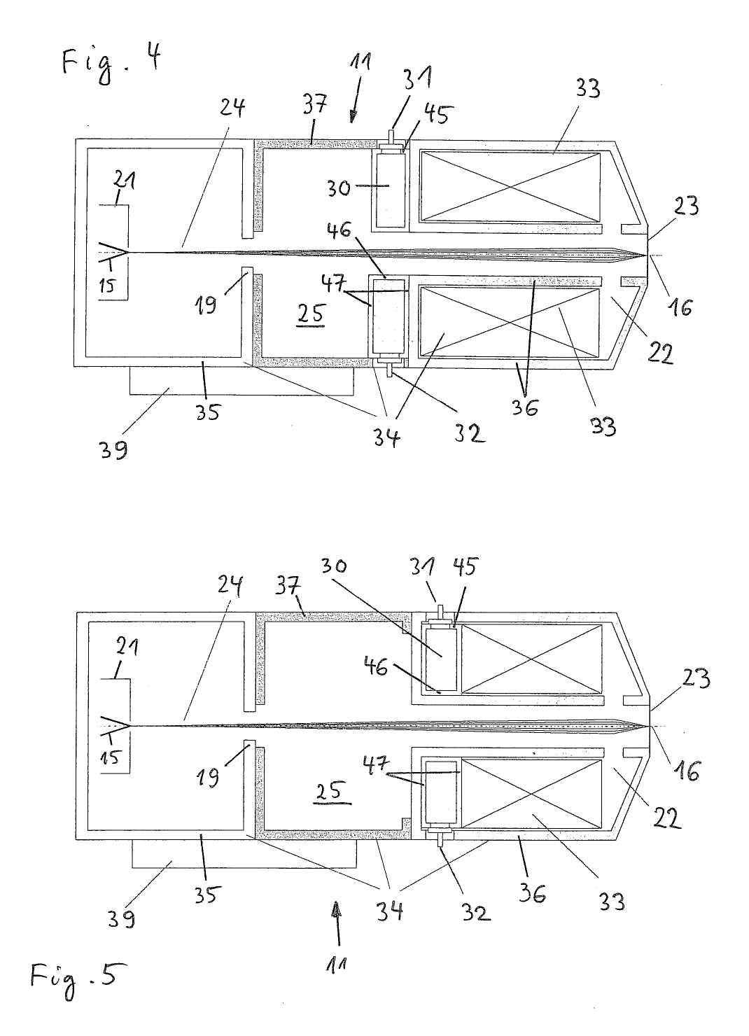

FIG. 4 a longitudinal cross-section through an X-ray tube in a second embodiment;

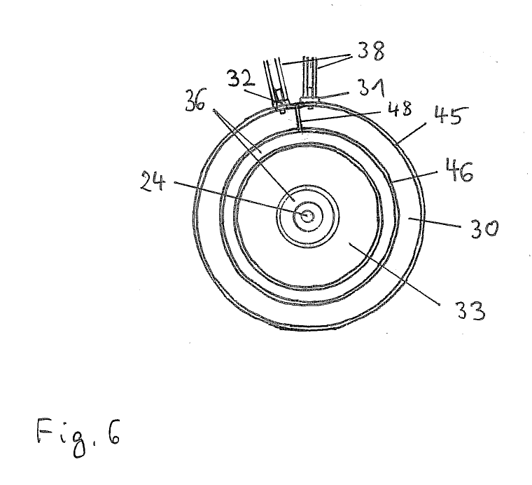

FIG. 5 a longitudinal cross-section through an X-ray tube in a third embodiment; and

FIG. 6 a cross-section through an X-ray tube perpendicular to the longitudinal axis in an embodiment alternative to FIG. 3.

The micro-computer tomography device shown in FIG. 1 comprises of an X-ray system 10, which is set-up to receive a set of x-ray projections of a sample 13. For this purpose, the X-ray system 10 includes a micro-focus X-ray tube 11, the X-rays 14 emitted outward from a focal point or focus 16 of the X-ray tube 11, an imaging X-ray detector 12, and a sample holder 20, which is preferably set up to rotate the sample 13 about a vertical axis. The X-ray detector 12 is preferably a surface detector, in particular a flat panel detector; however, even a line detector is possible. A set of X-ray projections of the sample 13 is obtained, for example, by stepwise rotation of the sample holder 20 about a defined small angular step respectively and recording an X-ray projection at each rotation angle. The X-ray system 10 is not limited to a rotation of the sample holder 20 about a vertical axis. Alternatively, for example, the X-ray tube 11 and the X-ray detector 12 may be rotated about the fixed sample 13.

The X-ray projections are read from the X-ray detector 12 and transmitted to a computer device 41, where reconstructed three-dimensional volume data of the sample 13 is calculated from the received set of x-ray projections by means of a basically known reconstruction algorithm and for example displayed on a screen 42. The computing device 41 may, as shown in FIG. 1, be likewise setup to control the X-ray source 11, the sample holder 20, and the X-ray detector 12; alternatively a separate control device can be provided.

The micro-focus X-ray tube 11 includes a cathode element 15, a Wehnelt cylinder 21, an anode 19, a focusing lens 22 preferably designed as electromagnetic lens, and an electron beam target 23. Furthermore, another electromagnetic lens 25 may be provided, which is preferably set up as condenser lens in order to align the electron beam 24 approximately parallel or to generate an intermediate image; the condenser lens 25 is, however, not required mandatorily. The micro-focus X-ray tube 11 further comprises of a deflector not shown for beam position adjustment advantageously. The micro-focus X-ray tube 11 is set up such that the minimum focus or focal spot on the target 23 is less than or equal to 10 m, preferably less than or equal to 4 m, even more preferably less than or equal to 2 m.

The micro-focus X-ray tube 11 further comprises of a housing, which can be composed of several sections. In particular, a cathode element 15 receiving and the anode 19 forming housing section 35, a housing section 36 surrounding the focusing lens 22 and optionally a median housing section 37 arranged intermediately, in which the condenser lens 25 may be arranged for example, may be provided. The housing 36 surrounding the coil 33 is advantageously free of thermally insulating, especially non-metallic shieldings or layers that would impede the setting of a thermal equilibrium.

The X-ray tube 11 comprises of an annular cooling chamber 30 having an inlet 31 and an outlet 32, which are combinable to a cooling circuit via coolant lines 38 with a coolant pump not shown. In this manner, a liquid cooling agent, in particular water or oil, flows through the cooling chamber 30 to counteract the entry of heat energy from various internal and external heat sources and an associated displacement of the focus point 16 relative to the tube fixing 39. The heat sources mentioned arise for example due to the impact of the electron beam 24 on the target 23, the energy dissipation in the electron optics 22 and the absorption of thermal energy over the surface of the tubular housing 34.

The cooling chamber 30 is closed in a ring-like in itself, as best seen in FIG. 3 and FIG. 6. In the embodiment according to FIG. 3, the fluid-filled interior of the cooling chamber 30 is entirely circumferentially continuous. In this embodiment, inlet 31 and outlet 32 are preferably offset to one another by 180°, as shown in FIG. 3, thus the cooling chamber 30 flows as uniformly as possible and forms no preferred direction of flow for the cooling medium.

In the embodiment according to FIG. 6, however, a radial partition wall 48 is provided in the cooling chamber 30, which interrupts the fluid-filled interior of the cooling chamber 30 at a circumferential location. In this case, inlet 31 and outlet 32 are preferably arranged in the region of the partition wall 48 on opposite sides of the same in order to achieve a complete flow of the cooling chamber 30. In this execution example, inlet and outlet can also be arranged axially displaced instead without circumferential offset substantially.

The embodiment according to FIG. 6 shows that the feature according to the invention “substantially rotationally symmetrical” means rotationally symmetrical except for inlets and outlets 31, 32 for the cooling agent, any partition walls 48 in the cooling chamber, and optionally further, the rotational symmetry of not significantly interfering functional elements. The terms axial, radial, and rotationally symmetrical refers to the longitudinal axis of the tube 11 in line with this application, which is defined by the central axis of the electron beam 24 between the cathode 15 and the target 23.

In the embodiment according to FIG. 2, the cooling chamber 30 is arranged around the tubular housing 34, in particular around the housing section 36 surrounding the focusing lens 22. In this embodiment, the cooling chamber 30 extends mainly axially, i.e. its axial extension is preferably at least twice as large as its radial extension. For example, the axial extension of the cooling chamber 30 can be adjusted to the axial extension of the coil 33 of the focusing lens 22.

In the embodiments according to FIG. 4 and FIG. 5, the cooling chamber 30 is arranged in the tubular housing 34. In the variant shown in FIG. 4, the cooling chamber 30 is arranged on the outside of the housing section 36 surrounding the focusing lens 22, here in the middle housing section 37. In the variant shown in FIG. 5, the cooling chamber 30 is arranged in the housing section 36 surrounding the focusing lens 22 immediately adjacent to the coil 33. In both embodiments, the cooling chamber 30 extends mainly radially, i.e., its radial extension is preferably at least 50% greater than its axial extension. For example, the radial extension of the cooling chamber 30 can be adjusted to the radial extension of the coil 33 of the focusing lens 22.

In the execution examples according to FIGS. 2, 4, and 5, the cooling chamber 30 is arranged adjacent to the coil 33 of the focusing lens 22, as this represents a major source of heat in the tube 11. The invention is, however, not limited to an adjacent arrangement of the cooling chamber 30 to the focusing lens 25.

In the embodiments according to FIG. 2 to FIG. 6, the cooling chamber exhibits the preferred form of an annular cylinder. The radial outer wall 45 and the radial inner wall 46 of the cooling chamber 30 are thus shaped cylindrically. The side walls 47 required to form a closed cooling chamber 30 are preferably disk-shaped.

The walls 45, 46, 47 forming the cooling chamber are preferably made of a material having a good thermal conductivity of at least 50 W/mK, in particular of a material on the basis of aluminum, copper, and/or brass.

As apparent from the FIGS. 2, 4, and 5, the cross-sectional area of the cooling chamber 30 in a longitudinal cross-section is more than ten times as large as the cross-sectional area of the cooling lines 38 to be connected with the cooling chamber 30 via the connections 31, 32. The flow rate of the cooling medium in the cooling chamber 30 is, therefore, preferably more than ten times smaller than cooling lines 38 to be connected with the cooling chamber 30 via the connections 31, 32. The clear internal dimensions of the cooling chamber 30 in a longitudinal cross-section are preferably greater than the wall thickness of the walls 45 to 47, so that as much installation space available as possible is usable as cooling agent volume. The mentioned above feature contributes to an efficient cooling due to a greatest possible volume of cooling in the cooling chamber 30 for a given size.

The invention is not limited to a coolant inlet 31, a coolant outlet 32, and optionally a partition wall 48. There are other embodiments possible with a plurality of coolant inlets 31, and/or a plurality of partition walls 48.

The tube 11 may have a plurality of cooling chambers 30, which, for example, can be arranged axially offset to one another.

The cooling chamber 30 has been described above in connection with a tube 11 with transmission target. The cooling chamber 30, however, can readily be used to advantage in a tube 11 with direct beam geometry alternatively, i.e., with reflection target.

The tube 11 has been described above for the preferred application in a CT device. However, other application for the industrial X-ray examination or X-ray measurement of components is possible. In general, the X-ray tube 11 can be used advantageously in a high-resolution X-ray device having an imaging detector.

What is claimed is:

1. A micro focus X ray tube for a high resolution X-ray apparatus, the X-ray tube comprising:
a housing having;
an electron beam source for generating an electron beam;
a focusing lens for focusing the electron beam; and
a substantially rotationally symmetrical, ring-shaped cooling chamber positioned within the housing configured to circulate a liquid cooling medium.

2. The X-ray tube according to claim 1, wherein the cross-sectional area of the cooling chamber in a longitudinal cross section is at least approximately five times as large as the cross-sectional area of at least one cooling duct which is connected to the cooling chamber.

3. The X-ray tube according to claim 1, wherein the cooling chamber comprises an orifice and a wall and wherein an internal dimension of the cooling chamber orifice in a longitudinal cross-section is larger than the wall thickness of the cooling chamber walls.

4. The X-ray tube according to claim 1, wherein the cooling chamber comprises the shape of an annular cylinder.

5. The X-ray tube according to claim 1, wherein an inlet and an outlet for the cooling medium in a circumferential direction of the tube are arranged offset to one another.

6. The X-ray tube according to claim 1, wherein an inlet and an outlet for the cooling medium are arranged opposite with respect to the tube axis.

7. The X-ray tube according to claim 1, wherein the cooling chamber is arranged adjacent to a coil of the focusing lens.

8. The X-ray tube according to claim 1, wherein the cooling chamber comprises a wall, the wall comprising a material having a thermal conductivity of at least approximately 50 W/mK.

9. The X-ray tube according to claim 1, wherein the cooling chamber comprises a wall, the wall comprises at least one of a material on the basis of aluminum, copper and brass.

10. A micro focus X-ray tube for a high resolution X-ray apparatus, the X-ray tube comprising:
a housing having;
an electron beam source for generating an electron beam;
a focusing lens for focusing the electron beam; and
a substantially rotationally symmetrical, ring-shaped cooling chamber, the cooling chamber includes an inlet and an outlet connected to a cooling circuit.

11. The X-ray tube according to claim 10, wherein the cooling circuit includes a pump.
